(19) United States
(12) Patent Application Publication
(10) Pub. No.: US 2024/0210857 A1
(43) Pub. Date: Jun. 27, 2024

(54) FIXING DEVICE

(71) Applicant: KYOCERA Document Solutions Inc., Osaka (JP)

(72) Inventor: Seia FUJII, Osaka (JP)

(73) Assignee: KYOCERA Document Solutions Inc., Osaka (JP)

(21) Appl. No.: 18/545,171

(22) Filed: Dec. 19, 2023

(30) Foreign Application Priority Data
Dec. 27, 2022 (JP) 2022-210430

(51) Int. Cl. G03G 15/20

(52) U.S. Cl. CPC G03G 15/2035; G03G 15/2028; G03G 2215/00548

(57) ABSTRACT

A fixing device includes a heating roller, a separation member and a fixing frame. The heating roller fixes a toner image on a sheet. The separation member separates the sheet from the heating roller. The fixing frame supports the separation member. The separation member includes a separation claw, a fulcrum shaft and a projection. The separation claw can abut on the heating roller. The fulcrum shaft extends parallel to a direction of a rotation axis of the heating roller. The projection is formed to extend away from the fulcrum shaft in a direction perpendicular to the shaft axis of the fulcrum shaft. The fixing frame includes a rib that restricts the movement of the projection in the direction of the rotation axis.

### INCORPORATION BY REFERENCE

This application is based upon and claims the benefit of priority from the corresponding Japanese Patent Application No. 2022-210430 filed on Dec. 27, 2022, the entire contents of which are incorporated herein by reference.

### BACKGROUND

The present disclosure relates to fixing devices.

As an example of a conventional image forming apparatus, there is an image forming apparatus which suppresses damage to a heating roller caused by a peeling claw.

### SUMMARY

A fixing device according to the present disclosure includes a heating roller, a separation member and a fixing frame. The heating roller fixes a toner image on a sheet. The separation member separates the sheet from the heating roller. The fixing frame supports the separation member. The separation member includes a separation claw, a fulcrum shaft and a projection. The separation claw can abut on the heating roller. The fulcrum shaft extends parallel to a direction of a rotation axis of the heating roller. The projection is formed to extend away from the fulcrum shaft in a direction perpendicular to the shaft axis of the fulcrum shaft. The fixing frame includes a rib that restricts the movement of the projection in the direction of the rotation axis.

Further objects of the present disclosure and specific advantages obtained by the present disclosure will become clearer from the description of an embodiment described below.

### BRIEF DESCRIPTION OF THE DRAWINGS

FIG. 1 is a diagram showing the configuration of a multi-functional peripheral which includes a fixing device according to the present embodiment;

FIG. 2 is a diagram showing the fixing device according to the present embodiment;

FIG. 3 is an enlarged cross-sectional view in which the main parts of the fixing device are enlarged;

FIG. 4 is a diagram when a separation member is viewed from the left side;

FIG. 5A is a diagram illustrating the operation of the separation member;

FIG. 5B is a diagram illustrating the operation of the separation member; and

FIG. 5C is a diagram illustrating the operation of the separation member.

### DETAILED DESCRIPTION

An embodiment of the present disclosure will be described below with reference to drawings. In the drawings, the same or corresponding parts are identified with the same reference signs, and repeated description is omitted.

Before the embodiment is described, a problem in a conventional image forming apparatus which suppresses damage to a heating roller caused by a peeling claw will be described. In the conventional image forming apparatus, no consideration is given to the fact that the peeling claw can be moved in the direction of the rotation axis of the heating roller. However, the surface of the heating roller is disadvantageously damaged by the peeling claw which can be moved in the direction of the rotation axis of the heating roller. In the conventional image forming apparatus, no consideration is given to this problem, and no measures are taken against this problem.

An object of the present disclosure is to provide a fixing device which suppresses damage to the circumferential surface of a heating roller caused by a tip of a separation claw that can be moved in the direction of the rotation axis of the heating roller.

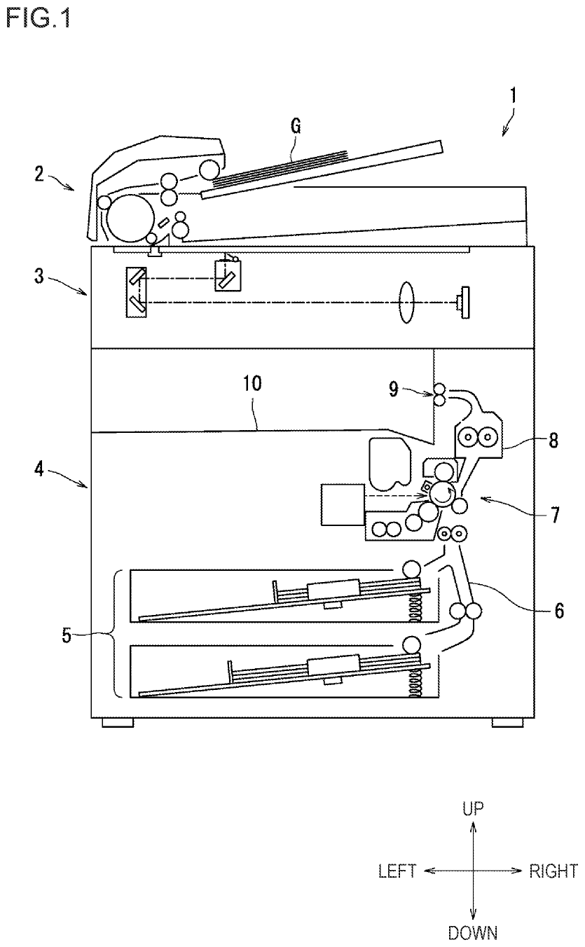

The embodiment will be described. A multi-functional peripheral 1 will first be described with reference to FIG. 1. FIG. 1 is a diagram showing the configuration of the multi-functional peripheral 1 which includes a fixing device 8 according to the present embodiment.

As shown in FIG. 1, the multi-functional peripheral 1 acquires image data from a document or acquires image data from an external server, cloud or terminal. The multi-functional peripheral 1 forms an image on a sheet based on the image data and outputs it. The multi-functional peripheral 1 is a device which combines an image data transmission/reception function, an image reading function and an image formation function. As an example, the multi-functional peripheral includes the functions of a scanner, a printer, a copying machine, a telephone, a printing machine, a facsimile and the like.

The cloud is a form which provides computer resources via a computer network such as the Internet, and as an example, the cloud includes an application, a platform and an infrastructure.

The server stores data and provides, when a request is made via a communication line, data corresponding to the request.

The multi-functional peripheral 1 May include a document conveying device 2, a document reading device 3 and an image forming apparatus 4. In the present embodiment, the document conveying device 2 and the document reading device 3 are not essential constituent elements.

The document conveying device 2 conveys a document G stored in a tray to the document reading device 3. An example of the document conveying device 2 is an ADF (Auto Document Feeder).

The document reading device 3 reads an image in the document G and outputs image information. An example of the document reading device 3 is a scanner.

The document reading device 3 generates image data from the read image. The document reading device 3 has a CIS (Contact Image Sensor) system or a CCD (Charge Coupled Devices) system.

The image forming apparatus 4 forms an image on a sheet.

The image forming apparatus 4 includes a feed device 5, a sheet conveying device 6, an image formation unit 7, the fixing device 8, a sheet ejection unit 9 and a sheet ejection tray 10.

The feed device 5 stores sheets in a feed tray. The feed device 5 feeds a sheet.

The sheet conveying device 6 conveys the sheet fed from the feed device 5 to the image formation unit 7.

The image formation unit 7 uses a toner to form an image on the sheet. When the image formation unit 7 has an electrophotographic system, the image formation unit 7 includes a photosensitive member, a charging device, an exposure device, a development device, a transfer device, a cleaning device and a static eliminator.

An example of the photosensitive member is a photosensitive drum. The photosensitive drum has a photosensitive layer on an outer circumferential surface. Examples of the photosensitive drum include a selenium drum and an OPC (Organic Photoconductor).

The charging device charges the photosensitive layer of the photosensitive member to a predetermined potential. An example of the charging device is a corona discharger.

The exposure device applies laser light to the photosensitive layer of the photosensitive member to expose the photosensitive layer. The exposure device exposes the photosensitive layer of the photosensitive member based on the image data. Consequently, an electrostatic latent image is formed on the photosensitive member. An example of the exposure device is an LED (Light Emitting Diode).

The development device stores, as an example, a two-component developer containing a carrier made of a magnetic material and a toner. The development device develops the electrostatic latent image formed with the toner on the photosensitive member to form a toner image on the photosensitive member.

The transfer device transfers the toner image on the photosensitive member to the sheet. The cleaning device removes a residual toner which is left on the photosensitive member after the transfer. The static eliminator eliminates static electricity from the photosensitive member.

The fixing device 8 heats and pressurizes the toner image developed on the sheet to fix the toner image on the sheet.

The sheet ejection unit 9 ejects the sheet to the outside of the main body of the image forming apparatus 4. The sheet ejection unit 9 includes sheet ejection rollers. The sheet ejection rollers eject, to the sheet ejection tray 10, the sheet conveyed from the fixing device 8 with the sheet conveying device 6. The sheet ejection tray 10 stores the ejected sheet.

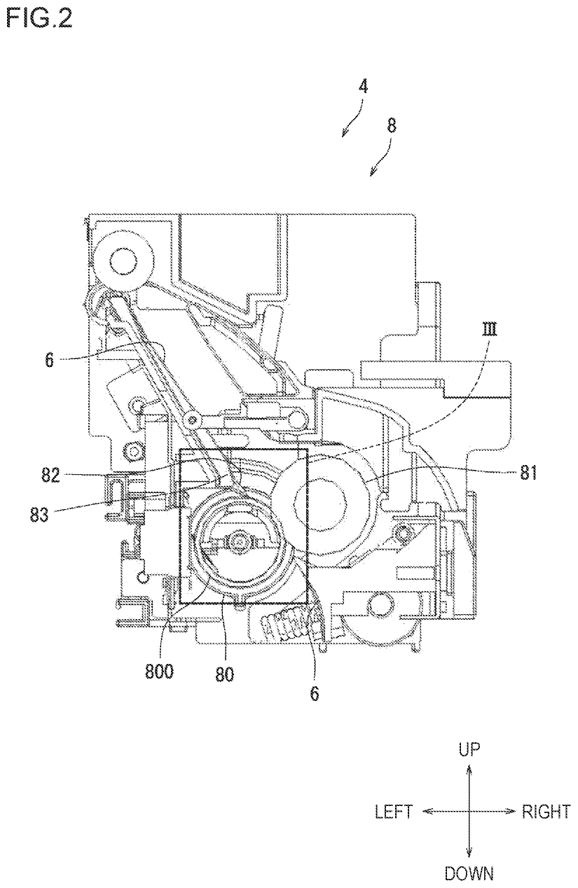

The fixing device 8 according to the present embodiment will then be described further with reference to FIG. 2 in addition to FIG. 1. FIG. 2 is a diagram showing the fixing device 8 according to the present embodiment.

As shown in FIG. 2, the fixing device 8 includes a heating roller 80, a pressure roller 81, a separation member 82 and a fixing frame 83.

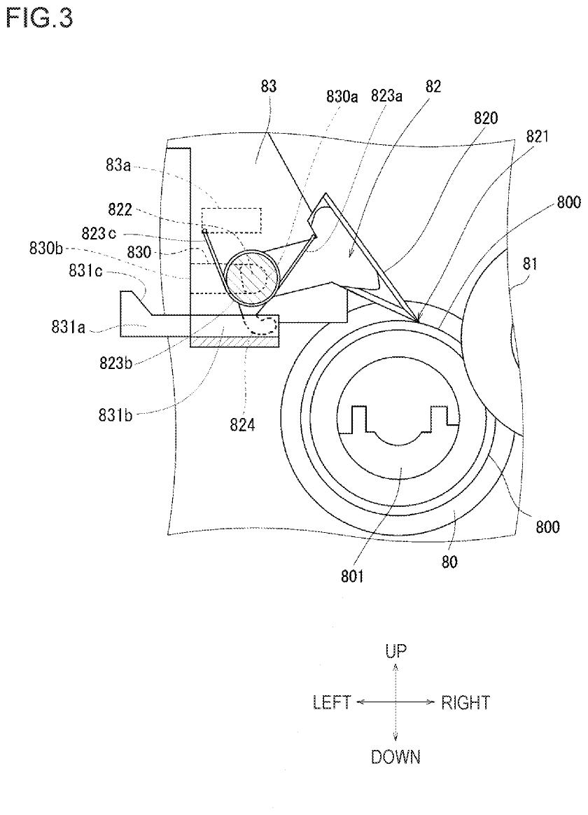

The heating roller 80 fixes the toner image on the sheet. The heating roller 80 is a hollow cylindrical roller. The heating roller 80 has an elastic layer 800 on its outer circumferential surface. The elastic layer 800 may be a release layer. The heating roller 80 has a heater 801 (FIG. 3) inside the heating roller 80.

The pressure roller 81 presses the heating roller 80. The pressure roller 81 forms a nip between the heating roller 80 and itself, and pressurizes the sheet which is passed through the nip.

The pressure roller 81 is driven by an unillustrated drive unit to rotate, and forms the nip between the heating roller 80 and itself to rotate the heating roller 80. The sheet conveyed by the fixing device 8 is passed through the nip, and thus the sheet is heated by the heater 801, with the result that the toner image is fixed.

The separation member 82 can be moved in the radial direction of the heating roller 80, and separates the sheet from the heating roller 80.

The fixing frame 83 supports the separation member 82. The fixing frame 83 May be a part of the frame of the fixing device 8. The fixing frame 83 May be a part of the housing of the image forming apparatus 4.

Then, with reference to FIGS. 3, 4 and 5A to 5C in addition to FIGS. 1 and 2, the separation member 82 and the fixing frame 83 will continue to be described.

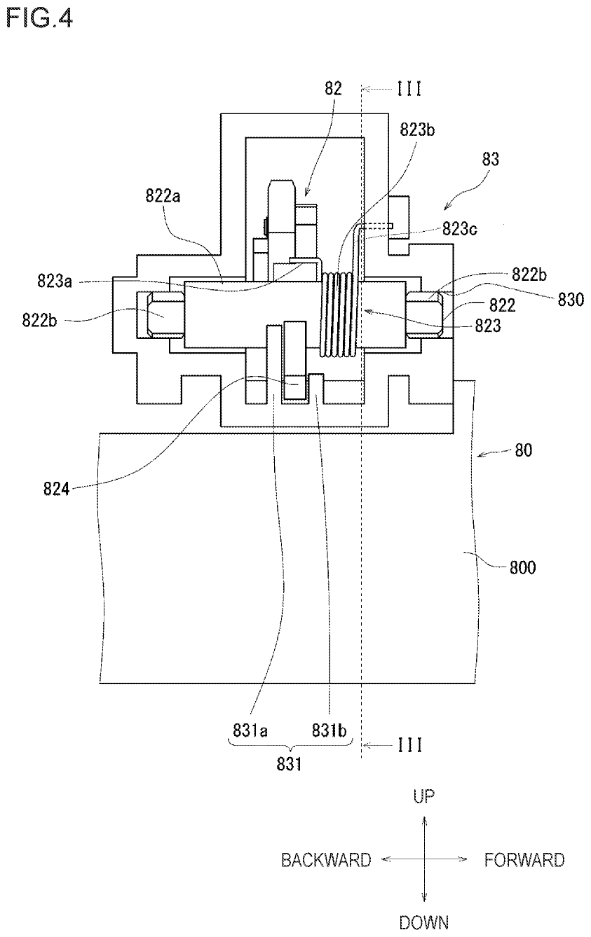

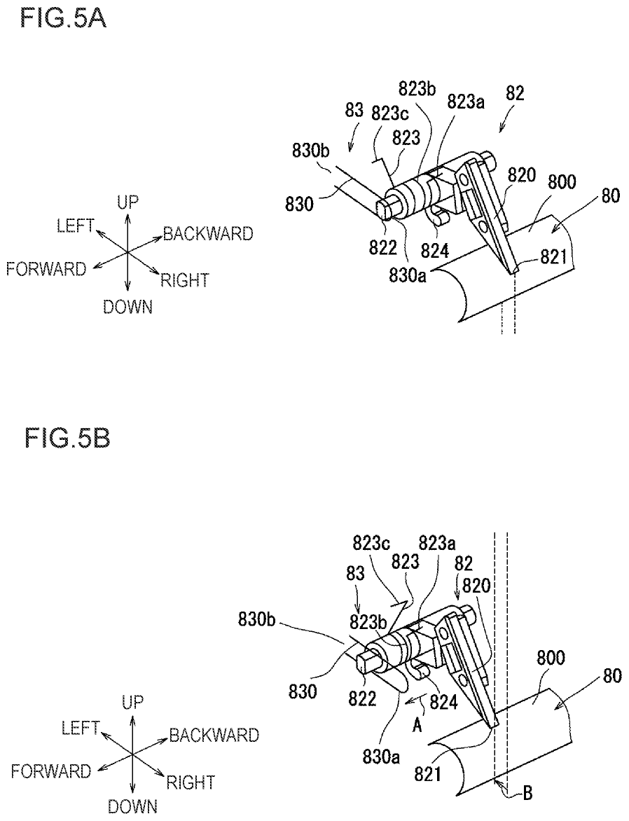

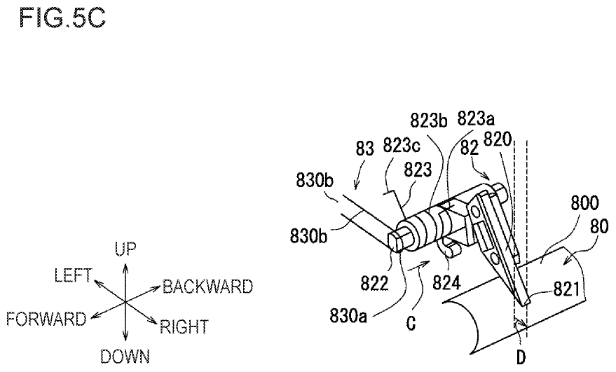

FIG. 3 is an enlarged cross-sectional view taken along line III-III of the fixing device 8 shown in FIG. 4 in which main parts are enlarged. FIG. 4 is a diagram when the separation member 82 is viewed from the left side. FIGS. 5A to 5C are diagrams illustrating the operation of the separation member 82.

As shown in FIGS. 3, 4 and 5A to 5C, the separation member 82 includes a separation claw 820, a tip 821, a fulcrum shaft 822, an elastic member 823 and a projection 824 (FIGS. 4 and 5A to 5C).

As shown in FIGS. 4 and 5A to 5C, the fixing frame 83 includes a sliding hole 830 and a rib 831.

As shown in FIGS. 3 and 5A to 5C, the sliding hole 830 further includes a right end 830a and a left end 830b. The inner wall surface of the right end 830a is formed in the shape of an arc, and the left end 830b is an opening which opens leftward. The sliding hole 830 is a U-shaped groove which extends from the left end 830b to the right end 830a.

Then, as shown in FIG. 3, in the separation claw 820, the tip 821 is formed.

In the separation claw 820, the tip 821 can abut on the heating roller 80.

The tip 821 of the separation claw 820 peels, from the heating roller 80, the sheet which has been passed through the nip formed between the heating roller 80 and the pressure roller 81.

As shown in FIGS. 4 and 5A to 5C, the fulcrum shaft 822 extends parallel to the direction (forward/backward direction) of the rotation axis of the heating roller 80. The fulcrum shaft 822 includes a large diameter portion 822a and a small diameter portion 822b. On the large diameter portion 822a, the elastic member 823 is provided. The small diameter portion 822b is inserted through the sliding hole 830 to be supported. The length of the large diameter portion 822a in the direction of the rotation axis is shorter than a distance along the rotation axis between a front wall surface, where the sliding hole 830 is formed, and a rear wall surface. When the separation member 82 is fitted into the sliding hole 830 of the fixing frame 83, the posture of the separation member 82 is changed, and thus the operation of inserting the small diameter portion 822b into the sliding hole 830 is easily performed.

As shown in FIGS. 4 and 5A to 5C, as an example, the elastic member 823 may be a torsion spring, or a torsion coil spring which is provided on the large diameter portion 822a of the fulcrum shaft 822.

As shown in FIGS. 4 and 5A to 5C, the elastic member 823 includes one end 823a, a body 823b and the other end 823c.

The one end 823a of the elastic member 823 is locked to the separation member 82. The body 823b of the elastic member 823 is wound in an annular shape, and as described above, is provided on the large diameter portion 822a of the fulcrum shaft 822. As shown in FIG. 3, the other end 823c of the elastic member 823 is locked to an opening 83a formed in the fixing frame 83. The other end 823c of the elastic member 823 may be locked to another member in the fixing device 8 or the image forming apparatus 4. When the other end 823c of the elastic member 823 is locked to the opening 83a of the fixing frame 83, the fulcrum shaft 822 of the separation member 82 is biased by the biasing force of the elastic member 823 such that the fulcrum shaft 822 abuts on the right end 830a of the sliding hole 830.

As shown in FIGS. 4 and 5A to 5C, the projection 824 of the separation member 82 May be formed to extend away from the fulcrum shaft 822 in a direction perpendicular to the shaft axis of the fulcrum shaft 822.

Then, as shown in FIGS. 3, 4 and 5A to 5C, the fulcrum shaft 822 is slidably fitted into the sliding hole 830 of the fixing frame 83 such that the separation claw 820 is brought into contact with and separated from the heating roller 80.

As shown in FIG. 4, the rib 831 of the fixing frame 83 includes a rear rib 831a and a front rib 831b. The rib 831 is provided to stand adjacent to both sides of the projection 824 in the direction of the rotation axis. The rear rib 831a extends leftward, and at the left end thereof, an inclined surface 831c which protrudes upward is formed.

As shown in FIG. 4, the rib 831 restricts the movement of the projection 824 in the direction (forward/backward direction) of the rotation axis of the heating roller 80. In other words, the rib 831 restricts the movement of the projection 824 in the direction (forward/backward direction) of the shaft axis of the fulcrum shaft 822.

In the present embodiment, for the problem in which the separation member 82 is moved in the direction (forward/backward direction) of the rotation axis of the heating roller 80 and thus the tip 821 of the separation claw 820 damages the circumferential surface of the elastic layer 800 of the heating roller 80, the rib 831 provided in the fixing frame 83 restricts the movement of the projection 824 of the separation member 82 in the direction (forward/backward direction) of the rotation axis of the heating roller 80.

Hence, it is possible to suppress the movement of the separation member 82 which is movable in the direction of the rotation axis of the heating roller 80 in the direction (forward/backward direction) of the rotation axis. In other words, in the fixing device according to the present embodiment, it is possible to suppress damage to the circumferential surface of the heating roller 80 caused by the tip 821 of the separation claw 820 which is movable in the direction of the rotation axis of the heating roller 80.

Furthermore, the rib 831 is provided to stand adjacent to one side or both sides of the projection 824 in the direction of the rotation axis, and thus the movement of the separation member 82 in the direction of the rotation axis can be more suitably suppressed.

Then, as shown in FIGS. 5A to 5C, the elastic member 823 biases the fulcrum shaft 822 in a direction approaching the heating roller 80 and biases the separation claw 820 such that the separation claw 820 abuts on the heating roller 80. In other words, the elastic member 823 biases the separation member 82 counterclockwise to cause the tip 821 of the separation claw 820 to abut on the surface of the heating roller 80.

The elastic member 823 biases and moves the fulcrum shaft 822 to the right end 830a along the sliding hole 830.

The elastic member 823 is provided on the circumferential surface of the fulcrum shaft 822. The position of the point of action of the one end 823a which abuts on the separation member 82 and the position of the point of action of the other end 823c which abuts on the fixing frame 83 are separate from each other in the axial direction. Hence, the elastic member 823 is slightly inclined to bias and move the fulcrum shaft 822 in the first direction (the forward direction or the direction of an arrow A) of the direction of the shaft axis of the fulcrum shaft 822.

When the fulcrum shaft 822 is moved in the sliding hole 830 in the direction away from the heating roller 80, the one end 823a and the other end 823c of the elastic member 823 are bent in the direction of wrapping around the large diameter portion. Hence, the fulcrum shaft 822 can be moved along the sliding hole 830 to the side of the left end 830b (the leftward direction or the direction of an arrow B). When the fulcrum shaft 822 is moved to a position where the fulcrum shaft 822 protrudes from the left end 830b of the sliding hole 830, the large diameter portion 822a of the fulcrum shaft 822 abuts on the inclined surface 831c to restrict its movement, and thus the separation member 82 is prevented from falling off from the fixing frame 83.

In the present embodiment, the movement of the separation claw 820 biased by the elastic member 823 in the direction of the rotation axis of the heating roller 80 can be suitably suppressed.

The operation of the separation member 82 will further be described in detail with reference to FIGS. 5A to 5C. FIGS. 5A to 5C show the behavior of the separation member 82 when the projection 824 is not locked by the rib 831 shown in FIG. 4.

As shown in FIG. 5A, the tip 821 of the separation claw 820 normally abuts on the circumferential surface of the heating roller 80. The fulcrum shaft 822 fitted into the sliding hole 830 abuts on the right end 830a of the sliding hole 830. In the direction of the rotation axis, the end surface of the large diameter portion 822a in the backward direction abuts on the wall surface of the fixing frame 83 in the backward direction.

When the sheet is normally passed through the nip formed by the heating roller 80 and the pressure roller 81 without jamming, the sheet stuck to the heating roller 80 is peeled off by the separation claw 820 and is conveyed by the sheet conveying device 6 (FIG. 2) to the sheet ejection unit 9 (FIG. 1).

In this case, the separation member 82 is constantly biased by the elastic member 823 in the rightward direction and in the backward direction. The elastic member 823 causes the tip 821 of the separation claw 820 to abut on the circumferential surface of the elastic layer 800 of the heating roller 80 by an appropriate biasing force. Hence, the tip 821 of the separation claw 820 does not damage the circumferential surface of the heating roller 80.

Then, the unillustrated sheet which has been passed through the nip formed by the heating roller 80 and the pressure roller 81 May be jammed for some reason. For example, the sheet may be deformed into the shape of a bellows.

As shown in FIG. 5B, the sheet deformed into the shape of a bellows collides with the separation claw 820 to bias the separation member 82 in the leftward direction (the direction of the arrow B). Depending on the state of the sheet deformed according to the magnitude of jamming, the separation member 82 May be moved in the leftward direction (the direction of the arrow B). The tip 821 of the separation claw 820 may also be significantly pressed toward the heating roller.

As shown in FIG. 5B, the fulcrum shaft 822 of the separation member 82 is also moved in the direction of the arrow B, and thus the fulcrum shaft 822 is separated from the right end 830a of the sliding hole 830 to move in the direction of the left end 830b of the sliding hole 830.

As the separation member 82 is moved in the direction of the arrow B as shown in FIG. 5B, the one end 823a and the other end 823c of the elastic member 823 are turned in the direction of wrapping around the body 823b. Hence, the movement of the separation member 82 in the direction of the arrow B is allowed. The one end 823a and the other end 823c are elastically deformed in the radial direction so as to be curved. Therefore, the movement of the separation member 82 in the direction of the arrow A is allowed, and thus the fulcrum shaft 822 protrudes in the sliding hole 830 in the direction of the arrow A.

In other words, when the state of the separation member 82 is changed from FIG.

5A to FIG. 5B, the separation claw 820 is moved in the direction of the arrow B and is also moved in the direction of the arrow A.

Then, when the separation member 82 is located in a position shown in FIG. 5B, if a user removes the jammed sheet, as shown in FIG. 5C, the basing force exerted by the sheet on the separation member 82 disappears.

As shown in FIG. 5C, the separation member 82 is moved in the backward direction (in the direction of an arrow C) by the biasing force of the elastic member 823. The fulcrum shaft 822 is moved in the sliding hole 830 in the rightward direction (in the direction of an arrow D) to abut on the right end 830a of the sliding hole 830. Then, the separation claw 820 is moved in the direction of the arrow D.

When the situation shown in FIG. 5B occurs, the tip 821 of the separation claw 820 strongly presses the elastic layer 800 of the heating roller 80 to depress the surface of the elastic layer 800. When in this state, the tip 821 is moved in the direction of the arrow B, since the tip 821 is moved in a direction away from the heating roller 80, the tip 821 does not damage the elastic layer 800. However, when the tip 821 is moved in the direction of the arrow A or in the direction of the arrow C, the tip 821 is moved while scraping the inclined surface of the depression, with the result that the elastic layer 800 may be damaged.

Hence, in the present embodiment, as shown in FIG. 4, the rib 831 is provided adjacent to the projection 824 of the separation member 82 in the forward/backward direction of the projection 824. The rib 831 may be provided adjacent to the projection 824 only in the forward direction of the projection 824.

The rib 831 may be provided adjacent to the projection 824 only in the backward direction of the projection 824. The rib 831 may be provided adjacent to the projection 824 both in the forward direction and in the backward direction of the projection 824.

The rib 831 restricts the movement of the fulcrum shaft 822 in the direction of the shaft axis. Hence, as described with reference to FIGS. 5A to 5C, when the sheet is jammed, the separation member 82 is moved in the leftward direction (in the direction of the arrow B), and thus the tip 821 of the separation claw 820 is retracted in a direction away from the heating roller 80, and the rib 831 suppresses the movement of the projection 824 in the forward/backward direction. Therefore, the movement of the tip 821 of the separation claw 820 in the forward/backward direction (in the direction of the arrow A and in the direction of the arrow C) is suppressed, and thus damage to elastic layer 800 caused by the tip 821 of the separation claw 820 is suppressed.

In other words, even when the separation member 82 is movable in the direction of the rotation axis of the heating roller 80 by the elastic member 823, the rib 831 formed in the fixing frame 83 suppresses the movement of the projection 824 formed in the separation member 82. Hence, even when the sheet is jammed, the movement of the separation claw 820 of the separation member 82 in the direction of the rotation axis of the heating roller 80 is suppressed. Therefore, damage to elastic layer 800 of the heating roller 80 caused by the tip 821 of the separation claw 820 is suppressed.

In the present disclosure, it is possible to provide a fixing device which suppresses damage to the circumferential surface of a heating roller caused by the tip of a separation claw that is movable in the direction of the rotation axis of the heating roller.

The embodiment of the present disclosure has been described above with reference to the drawings. However, the present disclosure is not limited to the embodiment described above, and the present disclosure can be practiced in various embodiments without departing from the spirit thereof. For ease of understanding, each of the drawings mainly and schematically shows its constituent elements, and the number of constituent elements shown in the drawing and the like can be different from the actual number and the like for convenience of the drawing. Each of the constituent elements shown in the embodiment is an example and is not particularly limited, and various changes can be made without substantially departing from the effects of the present disclosure

The present disclosure can be utilized in the field of fixing devices.

What is claimed is:

1. A fixing device comprising:
a heating roller that fixes a toner image on a sheet;
a separation member that separates the sheet from the heating roller; and
a fixing frame that supports the separation member, wherein the separation member includes
a separation claw that can abut on the heating roller and
a fulcrum shaft that extends parallel to a direction of a rotation axis of the heating roller and
a projection that is formed to extend away from the fulcrum shaft in a direction perpendicular to a shaft axis of the fulcrum shaft, and
the fixing frame includes a rib that restricts a movement of the projection in the direction of the rotation axis.

2. The fixing device according to claim 1,
wherein the rib is provided to stand adjacent to one side or both sides of the projection in the direction of the rotation axis.

3. The fixing device according to claim 1,
wherein the separation member further includes an elastic member that biases the fulcrum shaft in a direction approaching the heating roller and biases the separation claw such that the separation claw abuts on the heating roller.

4. The fixing device according to claim 1,
wherein an elastic layer is formed on a circumferential surface of the heating roller.

5. The fixing device according to claim 2,
wherein an elastic layer is formed on a circumferential surface of the heating roller.

6. The fixing device according to claim 3,
wherein an elastic layer is formed on a circumferential surface of the heating roller.
